(19) United States
(12) Patent Application Publication
(10) Pub. No.: US 2009/0274957 A1
(43) Pub. Date: Nov. 5, 2009

(54) BATTERY CAN AND METHOD FOR PRODUCING THE SAME AND APPARATUS FOR PRODUCING BATTERY CAN

(75) Inventors: Yoshio GODA, Osaka (JP); Satoru Sumikawa, Kanagawa (JP); Seiichi Kato, Osaka (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/505,114

(22) Filed: Jul. 17, 2009

Related U.S. Application Data
(63) Continuation of application No. PCT/JP2008/002080, filed on Aug. 1, 2008.

(30) Foreign Application Priority Data
Aug. 3, 2007 (JP) 2007-203428

(51) Int. Cl. H01M 2/02; B21D 22/21

(52) U.S. Cl. 429/164; 72/348

(57) ABSTRACT

A bottomed cylindrical battery can of the present invention includes a bottom wall and a side wall each having a predetermined thickness and being uniform in thickness. Alternatively, the bottomed cylindrical battery can of the present invention includes a side wall having a predetermined thickness and being uniform in thickness therethroughout and a bottom wall having a bottom wall thickness increasing from the periphery to the center thereof. By thus configuring, it is possible to reduce the weight of the battery can without sacrificing the rigidity of the battery can, while achieving a reduction in the amount of material used.

### TECHNICAL FIELD

The present invention relates to a battery can and a method for producing the same, and an apparatus for producing a battery can. Specifically, the present invention relates to improvements to a battery can.

### BACKGROUND ART

Conventionally, a battery can serving as a negative electrode of a manganese dry battery has been made of zinc and has been formed into a bottomed cylindrical shape utilizing impact molding (an impact backward extruding method) (see, for example, Patent Documents 1 to 3). FIGS. 8A to 8C are longitudinal sectional views showing a conventional production method of a battery can 47, the method using a press unit 51 for impact molding. FIG. 8A illustrates a step of supplying a pellet. FIG. 8B illustrates a backward extrusion step. FIG. 8C is a longitudinal sectional view showing a step of releasing the battery can 47. FIG. 9 is an enlarged longitudinal sectional view showing a main part of the step illustrated in FIG. 8B.

The press unit 51 for impact molding includes a die holder 40, an impact die 41, a punch holder 42, an impact punch 43, and a stripper 44. The die holder 40 supports the impact die 41. The impact die 41 is provided with a circular recess 41a formed on a surface thereof facing the impact punch 43. In the recess 41a, a pellet 38 made of a metallic raw material with extensibility is inserted. The impact holder 42 supports the impact punch 43 reciprocally movably in the longitudinal direction thereof.

The impact punch 43, which is a cylindrical member that is vertically reciprocated by an ascending/descending means (not shown), presses the pellet 38 inserted in the recess 41a of the impact die 41. The stripper 44, which is provided with a through-hole in the thickness direction thereof for allowing the insertion of the impact punch 43 therethrough, aids the release of the battery can 47 from the tip end of the impact punch 43 as the impact punch 43 moves away from the impact die 41 upon completion of molding of the battery can 47.

In the step illustrated in FIG. 8A, the pellet 38 is inserted in the recess 41a of the impact die 41. Zinc is generally used for the pellet 38 because of its extensibility suitable for impact molding and because the reduction in weight of the resultant battery can 47 can be achieved.

In the step illustrated in FIG. 8B, the impact punch 43 descends, and the tip end thereof is pressed into the recess 41a. The pellet 38 is squeezed by the impact punch 43 and forced into the clearance between the outer peripheral surface of the impact punch 43 and the inner peripheral surface of the recess 41a. As this proceeds, the pellet 38 is stretched along the outer peripheral surface of the impact punch 43, and thus forged. The impact punch 43 descends by a predetermined stroke. In such a manner, the pellet 38 is formed into a bottomed cylindrical battery can 47.

In the step illustrated in FIG. 8C, the impact punch 43 ascends and returns to the origin where the impact punch 43 had been positioned before descending. As the impact punch 43 ascends, the battery can 47 is pulled out of the recess 41a while being adhered to the tip end of the impact punch 43, and then released from the impact punch 43 by the aid of the stripper 44. Having been formed in a single process by impact molding, the battery can 47 is subjected to a minor finishing process, whereby a battery can as a product is obtained. The finishing process includes, for example, correcting a defective deformation, cutting the opening end of the bottomed cylindrical can to obtain a smooth opening rim surface, and others.

The conventional battery can 47, because of its production process comprising an impact molding process and subsequent minor finishing process, has an advantage in that mass production thereof with high productivity is possible. With impact molding only, however, it is difficult to obtain a reduced and uniform thicknesses of the side wall and the bottom wall of the battery can 47 for the reasons as described below. This poses a problem that zinc as a raw material is used more than necessary. Specifically, the prices of metal materials have risen globally in recent years, and there also has been a rise in zinc price. Moreover, manganese dry batteries using a zinc-made battery can are considerably less expensive as compared to other batteries, meaning that in manganese dry batteries, the ratio of material costs to production costs is very high. As such, when zinc is used more than necessary, the production costs of manganese dry batteries is significantly increased.

The thickness of the side wall of the battery can 47 processed by impact molding is dependent on the clearance between the peripheral surface of the impact punch 43 and the recess 41a. For this reason, it is necessary to position the impact punch 43 and the recess 41a so that the centers thereof or the axes thereof exactly coincide with each other. However, such positioning requires a high degree of skill. Moreover, even if the punch and the recess are positioned precisely, the impact punch 43 may be displaced when pressed into the recess 41a.

As shown in FIG. 9, the impact punch 43 includes a circular pressing surface 43a, a guide tapered surface 43b, a rounded portion 43c, an inner-diameter forming portion 43d, a tapered portion 43e, and a small-diameter portion 43f. The circular pressing surface 43a, which is a circular flat surface formed in the center of the end surface of the impact punch 43 from which the impact punch 43 is pressed into the recess 41a (hereinafter simply referred to as the “end surface”), squeezes the pellet 38.

The guide tapered surface 43b is a surface on the end surface, extending from the periphery of the circular pressing surface 43a toward the outer peripheral surface of the impact punch 43 (specifically, the inner-diameter forming portion 43d). The guide tapered surface 43b is tapered such that the inner diameter thereof is increased with distance from the circular pressing surface 43a. Since the guide tapered surface 43b is provided, the pellet 38 squeezed by the circular pressing surface 43a flows along the guide tapered surface 43b and enters the clearance between the outer peripheral surface of the impact punch 43 and the inner peripheral surface of the recess 41a.

The rounded portion 43c is a surface having an arc-shaped cross section provided at the boundary between the guide tapered surface 43b and the inner-diameter forming portion 43d. The rounded portion 43c regulates the flow of the squeezed pellet 38 toward the clearance between the outer peripheral surface of the impact punch 43 and the inner peripheral surface of the recess 41a. The inner-diameter forming portion 43d, which is provided continuously from the end surface, adjusts the inner diameter of a battery can 47. The tapered portion 43e, which is tapered such that the inner diameter thereof is reduced with the distance from the end surface, is an intermediate portion between the inner-diameter forming portion 43d and the small-diameter portion 43f. To the small-diameter portion 43f, an ascending/descending means (not shown) is connected.

In the process of impact molding, the circular pressing surface 43a of the impact punch 43 pressed down into the recess 41a squeezes the pellet 38. The squeezed pellet 38 flows along the guide tapered surface 43b obliquely upward toward the outer peripheral surface and passes through the narrow clearance between the rounded portion 43c and the recess 41a with high pressure and at high speed. As such, a high pressure is applied to the rounded portion 43c. The magnitude of the pressure applied thereto, however, is not always constant, causing a change in the flow of the material passing over the rounded portion 43c. As a result, the position of the impact punch 43 is displaced, and the impact punch 43 and the recess 41a become eccentric.

Further, since being provided over the circumferential edge of the impact punch 43, the rounded portion 43c may be slightly nonuniform in shape. Such nonuniformity in shape will also change the flow of the material passing over the rounded portion 43c, causing the impact punch 43 and the recess 41a to be eccentric. Furthermore, if the pellet 38 has a punching burr, punching sag, flaw, or the like, the impact punch 43 may be displaced in a certain direction at the moment when the impact punch 43 comes into contact with the pellet 38.

Due to such displacement of the impact punch 43, a side wall 47a of the molded battery can 47 is likely to have different side thicknesses D1 and D2. The side wall 47a of the battery can 47 functions as a power generation element of the negative electrode in a battery, and therefore the thickness thereof is gradually reduced as zinc is dissolved from the inner peripheral surface thereof. For this reason, the minimum allowable thickness of the side wall 47a is determined on the assumption that the thickness of the side wall is reduced. In the production, taking into consideration the variation in side wall thickness due to the eccentric displacement of the impact punch 43, the minimum allowable thickness is determined with reference to a predictable smallest thickness. Accordingly, the side wall 47a inevitably has a thickness greater than the predicted smallest thickness. Such a great thickness is not necessary for a battery, and the excess thickness means an excessive use of zinc as a raw material.

Furthermore, the inner-diameter forming portion 43d has a largest inner diameter among the potions of the impact punch 43, but has only a short length in the longitudinal direction of the impact punch 43. Above the inner-diameter forming portion 43d, the tapered portion 43e and the small-diameter portion 43f whose inner diameters are smaller than that of the inner-diameter forming portion 43d are provided. As such, the thickness of the side wall 47a continuously and gradually increases with distance from a bottom wall 47b. In the opening end or the vicinity thereof of the battery can 47, such a great thickness of the side wall 47a is useful in securing the sealing strength; however, below the opening end or the vicinity thereof, such a great thickness exceeds the necessary level, which also means an excessive use of raw material.

In addition, the corner being a boundary between the bottom wall 47b and the side wall 47a is shaped by the guide tapered surface 43b of the impact punch 43 so as to have a thickness much greater than necessary for securing the strength, where the material is used in excess. However, this excessively thick portion cannot be eliminated because the guide tapered surface 43b is indispensable in the process of impact molding.

A thickness D3 in the center of the bottom wall 47b is precisely formed by adjusting the distance of the clearance between the circular pressing surface 43a and the bottom surface of the recess 41a. In view of the fact that the bottom wall 47b hardly functions as a power generation element of a battery, it is considered desirable to reduce the thickness D3 as small as possible within a range with which a necessary strength is secured, and reduce the amount of material used. However, if the thickness D3 is reduced, in the step illustrated in FIG. 8C, as the tip end of the impact punch 43 is pulled out of the battery can 47, the internal pressure of the battery can 47 becomes negative pressure, and the center of the bottom wall 47b is disadvantageously warped inward.

### Patent Document 1: Japanese Laid-Open Patent Publication No. 2006-59546

Patent Document 2: Japanese Laid-Open Patent Publication No. Hei 8-17424
Patent Document 3: Japanese Laid-Open Patent Publication No. Hei 8-17425

### DISCLOSURE OF THE INVENTION

### Problem to be Solved by the Invention

As discussed above, there has been a problem in the conventional art as disclosed in the foregoing Patent Documents in that, since the impact punch 43 and the recess 41a as shown in FIG. 8C are easily become eccentric, the variation in the side wall thickness due to the eccentric displacement of the impact punch 43 must be taken into consideration in predicting the reduction in thickness that gradually occurs as zinc is dissolved from the inner peripheral surface, and therefore the zinc as a raw material is used in excess.

In addition, as shown in FIG. 9, the thickness of the side wall 47a continuously and gradually increases with distance from the bottom wall 47b, which also means an excessive use of raw material.

Moreover, since the guide tapered surface 43b is indispensable in the process of impact molding, the corner being a boundary between the bottom wall 47b and the side wall 47a is shaped so as to be much thicker than necessary for securing the strength, where the material is also used in excess.

The present invention has been achieved in view of the above-discussed conventional problems, and intends to provide a bottomed cylindrical battery can in which a bottom wall and a side wall have a predetermined thickness, and the thicknesses of the bottom wall and the side wall are respectively uniform, a method for producing a bottomed cylindrical battery can by which the aforementioned battery can is industrially advantageously produced with high precision, and an apparatus for producing a bottomed cylindrical battery can with which the aforementioned production method of a battery can is realized.

### Means for Solving the Problem

In order to achieve the above-described purpose, a bottomed cylindrical battery can of the present invention includes a side wall and a bottom wall made of a metallic raw material with extensibility, wherein the side wall has a predetermined side wall thickness, the side wall being uniform in thickness and having an opening at one end in the longitudinal direction thereof; and the bottom wall has a predetermined bottom wall thickness, the bottom wall thickness being uniform or increasing from the periphery to the center thereof.

It is preferable that the bottom wall is formed by sandwiching and squeezing the bottom wall of a bottomed cylindrical cup-shaped workpiece having an open end in the longitudinal direction thereof, between two flat planes facing each other in parallel or between a concave plane and a flat plane.

It is preferable that the side wall is formed by swaging a predetermined portion of the bottom wall and the side wall of the bottomed cylindrical cup-shaped workpiece having an open end in the longitudinal direction thereof.

Further, it is preferable that the battery can of the present invention further includes a reinforced thick-wall portion and a sealing portion, wherein the reinforced thick-wall portion is provided at a boundary between the bottom wall and the side wall and has a thickness greater than the bottom wall thickness and greater than the side wall thickness, and the sealing portion is provided at an opening end of the battery can or the vicinity thereof and has a thickness greater than the side wall thickness.

It is preferable that the battery can of the present invention furthermore includes a fine line formed on the peripheral surface of the side wall, the line extending along the circumference of the side wall.

It is preferable that the metallic raw material is zinc, aluminum, or magnesium.

The bottom wall thickness is preferably 0.1 to 0.4 mm, and the side wall thickness is preferably 0.1 to 0.6 mm.

Furthermore, the present invention provides a method for producing a bottomed cylindrical battery can comprising the steps of forming a cup-shaped workpiece, adjusting a bottom wall thickness, and adjusting a side wall thickness, wherein

in the step of forming a cup-shaped workpiece, a cup-shaped workpiece is formed by impact molding, the cup-shaped workpiece comprising a metallic raw material with extensibility, having an opening at one end in the longitudinal direction thereof, and having an inner diameter greater than that of a battery can to be produced,

in the step of adjusting a bottom wall thickness, a shaping core is inserted into the cup-shaped workpiece, the shaping core having an outer diameter equal to the inner diameter of the battery can to be produced and having an end surface being flat or concave at an end thereof, so that a flat or concave plane is brought into contact with the outer surface of the bottom wall of the cup-shaped workpiece; and while the end surface of the shaping core and the flat or concave plane are held so as to face each other in parallel, the bottom wall of the cup-shaped workpiece is sandwiched and squeezed between the end surface of the shaping core and the flat or concave plane, so that the bottom wall is processed to have a uniform thickness or to have a thickness increasing from the periphery to the center of the bottom wall, and is provided with increased resistance to pressure; and

in the step of adjusting a side wall thickness, swaging is performed by applying pressure to the outer peripheral surface of the side wall of the cup-shaped workpiece while rotating the cup-shaped workpiece with the shaping core inserted thereinto, so that the metallic raw material composing the side wall is plastically deformed and the side wall is made uniform in thickness by the pressing of the outer peripheral surface of the shaping core onto the inner peripheral surface of the side wall.

It is preferable that in the step of adjusting a bottom wall thickness, the shaping core further has an annular inclined surface formed by chamfering on the circumference of the end surface thereof to be brought into contact with the inner surface of the bottom wall of the cup-shaped workpiece; and in the step of adjusting a side wall thickness, the annular inclined surface of the shaping core is pressed onto a boundary between the bottom wall and the side wall containing the metallic raw material in a plastically deformed state, thereby to form a reinforced thick-wall portion having a thickness at the boundary, the thickness being greater than the bottom wall thickness and greater than the side wall thickness.

It is preferable that in the step of adjusting a side wall thickness, in performing swaging by pressing the outer peripheral surface of the side wall of the cup-shaped workpiece in a rotating state, swaging is started from the bottom of the outer peripheral surface of the side wall of the cup-shaped workpiece and stopped at a predetermined point below the opening end of the outer peripheral surface of the side wall of the cup-shaped workpiece, and then further swaging is performed such that the thickness of the metallic raw material in a plastically deformed state to be pressed onto the outer peripheral surface of the shaping core is increased.

Still further, the present invention provides an apparatus for producing a bottomed cylindrical battery can, comprising:

an impact molding unit for molding a pellet of metallic raw material with extensibility into a bottomed cylindrical cup-shaped workpiece having an opening at one end in the longitudinal direction thereof and having an inner diameter greater than that of a battery can to be produced;

a rotary holding table having a flat fixing plane for placing the cup-shaped workpiece thereon such that the outer surface of the bottom wall of the cup-shaped workpiece is brought into contact therewith;

a shaping core having an outer diameter equal to the inner diameter of the battery can to be produced and having an end surface being flat or concave at an end thereof to be brought into contact with the inner surface of the bottom wall of the cup-shaped workpiece;

a pressing unit for holding the shaping core such that the end surface of the shaping core and the flat plane of the rotary holding table face each other in parallel, and supporting the shaping core reciprocally movably in the longitudinal direction of the cup-shaped workpiece;

a rotary driving means for rotating at least one of the shaping core and the rotary holding table; and

a swaging unit including: a swaging tool to be pressed onto the outer peripheral surface of the side wall of the cup-shaped workpiece in a rotating state so that the side wall is plastically deformed; and a numerical control unit for numerically controlling the movement of the swaging tool.

It is preferable that the shaping core further has an annular inclined surface formed by chamfering on the circumference of the end surface thereof to be brought into contact with the cup-shaped workpiece.

It is preferable that the swaging tool is either a tool including a spherical swaging member and a supporting member for rotatably supporting the spherical swaging member or a spatula-like tool.

### EFFECT OF THE INVENTION

In the battery can of the present invention, the side wall has a predetermined thickness and the side wall thickness is uniform. Therefore, the side wall thickness can be set to a minimum allowable thickness that is determined on the assumption that the thickness of the side wall, which functions as a power generation element in the battery, is reduced due to the dissolution of raw material from the inner surface of the side wall. As such, the entire side wall can be formed to a necessary minimum side wall thickness, and as a result, the amount of metallic raw material used can be significantly reduced as compared to that used in the conventional battery can, allowing the material costs to be reduced.

Further, the battery can of the present invention includes an embodiment in which the bottom wall has a predetermined bottom wall thickness and the bottom wall thickness is uniform. Therefore, the bottom wall thickness can be also set to a thickness capable of ensuring the necessary minimum strength for a battery can. As such, it is possible to further reduce the amount of metallic raw material used, and thus to further reduce the material costs. Furthermore, in this configuration, since the side wall thickness and the bottom wall thickness are both uniform and thin, when the outer dimensions are made identical to those of the conventional battery can, the interior volume is increased by an amount equal to the reduction in the side wall thickness and the bottom wall thickness, which makes an improvement in the capacity of the battery possible.

Furthermore, the battery can of the present invention includes an embodiment in which the bottom wall has a thickness increasing from the periphery to the center of the bottom wall. As such, the resistance to pressure of the battery can is improved, and at the same time, the amount of metallic raw material used can be reduced since the side wall is formed to a uniform wall thickness. Therefore, according to this embodiment, it is possible to achieve both a reduction in material costs and an improvement in the resistance to pressure of the battery can.

According to the production method of a battery can of the present invention, since the production of a cup-shaped workpiece is produced in a single process by impact molding, the high productivity can be maintained. Further, since the cup-shaped workpiece has almost the same shape as a battery can to be produced, it is easy to adjust the bottom wall thickness and the side wall thickness in the subsequent steps. In the step of adjusting a bottom wall thickness, since the bottom wall thickness is adjusted by applying pressure on both side of the bottom wall of the cup-shaped workpiece in the thickness direction thereof with flat planes, the bottom wall can be easily adjusted to a desired thickness, and the thickness is made uniform throughout the bottom wall. Furthermore, at the end of the step of adjusting a bottom wall thickness, since the bottom wall of the cup-shaped workpiece is fixed by being sandwiched between two flat planes or between a concave plane and a flat plane, rotating these in this state allows swaging to be easily performed. As such, the step of adjusting a bottom wall thickness can be swiftly transferred to the subsequent step of adjusting a side wall thickness.

Finally, in the step of adjusting a side wall thickness, since the side wall of the cup-shaped workpiece is processed by swaging, the side wall thickness can be easily adjusted to a predetermined thickness and to be uniform. As described above, according the production method of the present invention, it is possible to reliably produce a bottomed cylindrical battery can including a bottom wall and a side wall having a predetermined bottom wall thickness and a predetermined side wall thickness, respectively, and each being uniform in thickness. It is also possible to reliably produce a bottomed cylindrical battery can including: a bottom wall having a bottom wall thickness that is not greater than necessary and increases toward the center thereof; and a side wall having a predetermined side wall thickness and being uniform in thickness.

### BRIEF DESCRIPTION OF THE DRAWINGS

FIG. 1 is a longitudinal cross-sectional view schematically showing a configuration of a battery can 1 according to one embodiment of the present invention.

FIG. 2A is a longitudinal cross-sectional view showing a step of supplying a pellet in a production method of a cup-shaped workpiece using a press unit for impact molding.

FIG. 2B is a longitudinal cross-sectional view showing a backward extrusion step in the production method of a cup-shaped workpiece using a press unit for impact molding.

FIG. 2C is a longitudinal cross-sectional view showing a step of releasing a cup-shaped workpiece in the production method of a cup-shaped workpiece using a press unit for impact molding.

FIG. 3 is an enlarged longitudinal cross-sectional view showing a main part of the step illustrated in FIG. 2B.

FIG. 4A is a longitudinal cross-sectional view schematically showing a configuration of the press unit and, in a step of adjusting a bottom wall thickness by a press unit, a step of supplying a cup-shaped workpiece to the press unit.

FIG. 4B is a longitudinal cross-sectional view schematically showing the configuration of the press unit and, in the step of adjusting a bottom wall thickness by the press unit, a step of adjusting the thickness of the bottom wall of the cup-shaped workpiece.

FIG. 5A is an enlarged longitudinal cross-sectional view showing a main part of the step illustrated in FIG. 4A.

FIG. 5B is an enlarged longitudinal cross-sectional view showing a main part of the step illustrated in FIG. 4B.

FIG. 6A is a longitudinal cross-sectional view schematically showing a configuration of a swaging unit and an early process of swaging in a step of adjusting a side wall thickness.

FIG. 6B is an enlarged longitudinal cross-sectional view showing a main part of the swaging unit and the early process of swaging shown in FIG. 6A.

FIG. 7 is a side view schematically showing a late process of swaging.

FIG. 8A is a longitudinal cross-sectional view showing a step of supplying a pellet in a conventional production method of a battery can.

FIG. 8B is a longitudinal cross-sectional view showing a backward extrusion step in the conventional production method of a battery can.

FIG. 8C is a longitudinal cross-sectional view showing a step of releasing a battery can in the conventional production method of a battery can.

FIG. 9 is an enlarged longitudinal cross-sectional view showing a main part of the step illustrated in FIG. 8B.

### BEST MODE FOR CARRYING OUT THE INVENTION

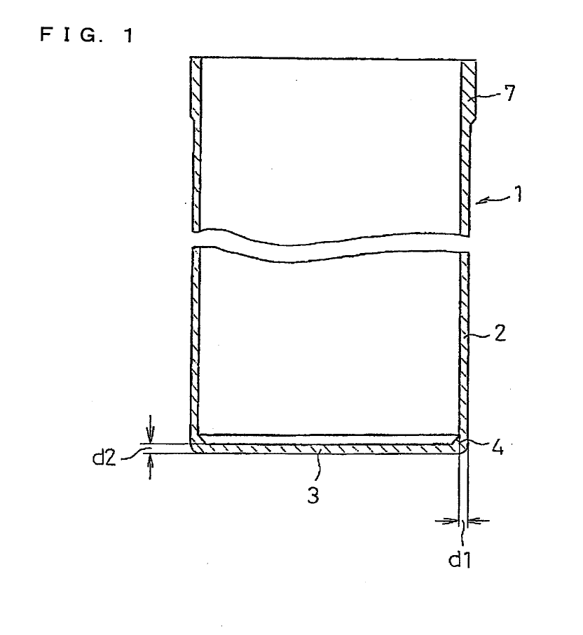

FIG. 1 is a longitudinal cross-sectional view schematically showing a configuration of the bottomed cylindrical battery can 1 according to one embodiment of the present invention. The battery can 1 is formed of zinc into a bottomed cylindrical shape having an opening at one end in the longitudinal direction thereof, and is suitably applicable, for example, to a manganese dry battery.

The battery can 1 includes a bottom wall 3, a side wall 2, a reinforced thick-wall portion 4, and a sealing portion 7.

The bottom wall 3 is formed by sandwiching and squeezing the bottom wall of a cup-shaped workpiece between two flat planes facing each other in parallel. Here, the cup-shaped workpiece is a bottomed cylindrical container member comprising a metallic raw material with extensibility and having an opening at one end in the longitudinal direction thereof. Preferred examples of the metallic raw material with extensibility include zinc, aluminum, magnesium, and the like.

The bottom wall 3 is a portion corresponding to the bottom of a battery to be produced with the use of the battery can 1. The bottom wall 3 has a predetermined thickness (bottom wall thickness) d2 and the bottom wall thickness d2 is uniform. The bottom wall thickness d2 can be uniformly reduced by the squeezing method as described above. Accordingly, the bottom wall can be formed so as to have a thickness with which the strength necessary for the bottom of the battery can be achieved, and a reduction in the amount of material used can be achieved. In addition, since the bottom wall thickness d2 is uniform throughout the bottom wall 3, if, for example, the internal pressure of the battery can 1 becomes negative pressure in the production thereof, the bottom wall 3 will not be warped inward.

Moreover, the bottom wall 3 hardly functions as a power generation element of the battery, and therefore the thickness thereof will not be reduced by the dissolution of material. For this reason, for example, the bottom wall thickness d2 can be made equal to or smaller than the below-mentioned thickness of the side wall 2 (side wall thickness d1). By doing this, the amount of zinc used as a raw material can be further reduced, and a further reduction in material costs and thus in production costs can be achieved.

The bottom wall thickness d2 is suitably selected according to the size of the battery can 1, and is preferably 0.1 to 0.4 mm and more preferably 0.2 to 0.4 mm. When the bottom wall thickness d2 is within the foregoing range, the minimum strength necessary for the battery can 1 is ensured. In addition, by providing the shaping core with a ring-shaped recess at any point around the circumference thereof, it is possible to produce a can having a thin side wall and a sufficient circumferential strength, while the amount of zinc to be used is just slightly increased. It is further possible to prevent the occurrence of dent in the process of assembling a battery. As such, it is possible to easily produce a battery can, while achieving a reduction in material costs in a more reliable manner. The bottom wall thickness d2 being uniform means that the bottom wall thicknesses measured at any 10 points on the bottom wall 3 all fall within the range of ±10% from the average of the measured values.

In this embodiment, the outer surface of the bottom wall 3 of the battery can 1 is flat, but not limited thereto, and may be concave toward the interior of the battery can 1.

Further, in another embodiment of the present invention, the bottom wall 3 may have a thickness increasing from the periphery to the center thereof. In this case, the outer surface of the bottom wall 3 of the battery can 1 is flat, and the inner surface of the bottom wall 3 of the battery can 1 protrudes in the center thereof toward the interior of the battery can 1. The battery can 1 including the bottom wall 3 as configured above has a pressure-resistant strength as high as the battery can 1 in which the outer surface of the bottom wall 3 of the battery can 1 is concave in the center thereof toward the interior of the battery can 1.

The side wall 2 is formed by swaging. The swaging is done by externally applying pressure to the side wall of the cup-shaped workpiece to plastically deform the metallic raw material and then to press the plastically deformed metallic raw material onto the outer peripheral surface of a reference columnar rod so that the side wall has a predetermined thickness. Here, the cup-shaped workpiece is, as described above, a bottomed cylindrical container member comprising a metallic raw material with extensibility and having an opening at one end in the longitudinal direction thereof. The reference columnar rod is, for example, a shaping core. It should be noted that, normally, the side wall 2 is formed after the formation of the bottom wall 3. The side wall 2 is a cylindrical member rising approximately vertically to the bottom wall 3 from the entire periphery of the bottom wall 3, one end of which in the longitudinal direction thereof continues to the bottom wall 3, and the other end of which is open.

The side wall 2 is a portion corresponding to the side of a battery to be produced with the use of the battery can 1. The side wall 2 has a predetermined thickness (side wall thickness) d1 and the side wall thickness d1 is uniform. In other words, the entire side wall 2 is uniformly formed to a predetermined side wall thickness d1, and there is no variation in the side wall thickness. By swaging, a uniform side wall thickness d1 can be obtained. It is possible, therefore, to adjust the side wall thickness d1 to the minimum allowable thickness, taking into consideration the reduction in thickness of the side wall 2 that occurs when the side wall 2 functions as a power generation element in the battery and the material of the side wall is dissolved from the inner peripheral surface thereof. As such, the amount of material used can be reduced and a significant reduction in material costs and thus in production costs can be achieved.

The side wall thickness d1 is suitably selected according to the size of the battery can 1, and is preferably 0.1 to 0.6 mm and more preferably 0.2 to 0.4 mm. When the side wall thickness d1 is within the foregoing range, the minimum strength necessary for the battery can 1 is ensured, and a reduction in material costs can be more reliably achieved. The side wall thickness d1 being uniform means that the side wall thicknesses measured at any 50 points on the side wall 2 all fall within the range of ±10% from the average of the measured values.

It is preferable that the outer peripheral surface of the side wall 2 have fine lines formed thereon so as to extend along the circumference of the battery can 1, the lines being formed as a result of swaging. In the case of covering the outer peripheral surface of the side wall 2 with an outer jacket, the retention of the outer jacket can be improved by the fine lines. Examples of the outer jacket include an outer jacket can, an outer jacket paper, a label, and the like.

The reinforced thick-wall portion 4 is provided on the entire circumference of the bottom of the battery can 1, where the bottom wall 3 and the side wall 2 meet, and has a thickness greater than the bottom wall thickness d2 and greater than the side wall thickness d1. The reinforced thick-wall portion 4 is formed as an inclined surface facing the diametrically opposite portion of the inner peripheral surface of the side wall 2 of the battery can 1, the inclined surface extending from the periphery of the inner surface of the bottom wall 3 to the bottom end of the inner peripheral surface of the side wall 2. The provision of the reinforced thick-wall portion 4 enables the battery can 1 to maintain its strength as a whole within a favorable range even when the bottom wall thickness d2 and the side wall thickness d1 are the respective minimum allowable thicknesses.

The sealing portion 7 is provided on the entire circumference of the battery can 1 at the opening end or the vicinity thereof of the battery can 1, and has a thickness greater than the side wall thickness d1. The provision of the sealing portion 7 enhances the sealing strength in assembling a battery from the battery can 1, enabling the production of a highly safe battery. It should be noted that the sealing portion 7 is preferably provided in a region extending from the opening end of the battery can 1 to about 0.2 to 0.6 mm below in the longitudinal direction of the battery can 1.

Since batteries are generally mass-produced, battery production with significantly reduced production costs is made possible by reducing the amount of metallic raw material used in the battery can 1 as described above. In the battery can 1, the amount of metallic raw material used is successfully reduced; and furthermore, the mechanical strength required as the battery can 1 is sufficient due to the reinforced thick-wall portion 4, and the sealing strength in assembling a battery is ensured by the sealing portion 7. In addition, since the side wall thickness d1 and the bottom wall thickness d2 can be made small and uniform as much as possible, when the outer dimensions of the battery can are made identical to those of the conventional battery can, the interior volume will be increased by an amount equal to the reduction in thickness of the side wall 2 and the bottom wall 3. Therefore, an improvement in the capacity of the battery can be achieved.

A method for producing a battery can according to the present invention includes the steps of forming a cup-shaped workpiece, adjusting a bottom wall thickness, and adjusting a side wall thickness.

In the step of forming a cup-shaped workpiece, a bottomed cylindrical cup-shaped workpiece 17 is formed by impact molding. The cup-shaped workpiece 17 is made of a metallic raw material with extensibility, and has an opening at one end in the longitudinal direction thereof and an inner diameter greater than that of a battery can to be produced. Examples of the metallic raw material with extensibility include zinc, aluminum, magnesium, and the like.

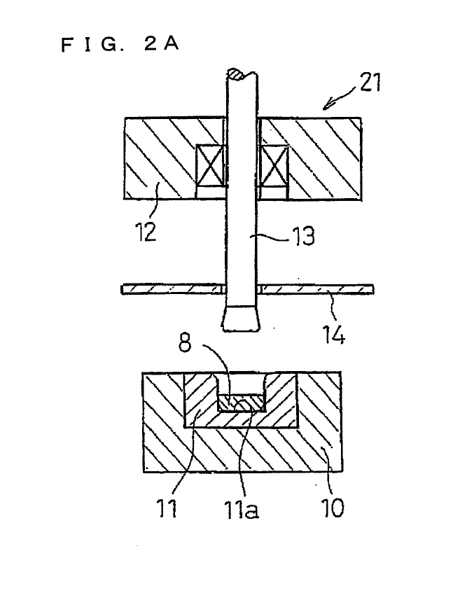

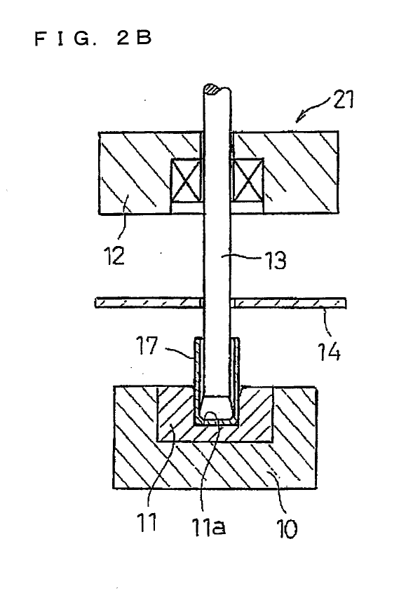

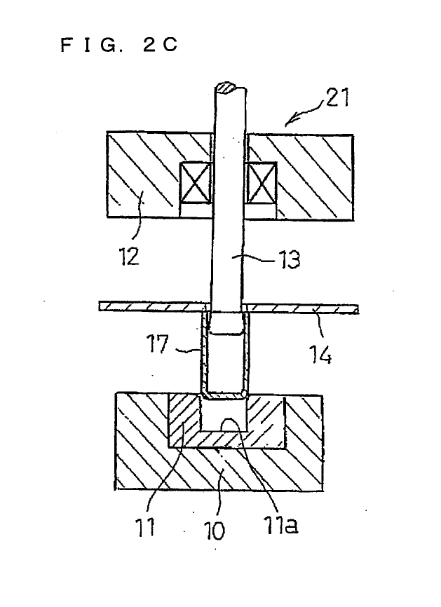

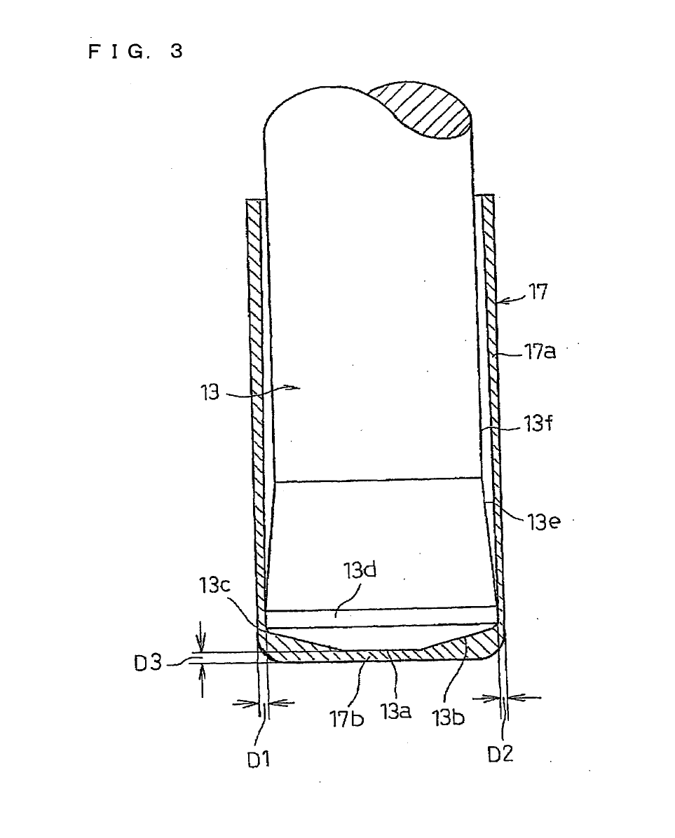

FIG. 2A to FIG. 2C are longitudinal cross-sectional views showing a production method of the cup-shaped workpiece 17, the method using a press unit 21 for impact molding. FIG. 2A illustrates a step of supplying a pellet. FIG. 2B illustrates a backward extrusion step. FIG. 2C illustrates a step of releasing the cup-shaped workpiece 17. FIG. 3 is an enlarged longitudinal sectional view showing a main part of the step illustrated in FIG. 2B.

The press unit 21 for impact molding includes a die holder 10, an impact die 11, a punch holder 12, an impact punch 13, and a stripper 14. The die holder 10 supports the impact die 11. The impact die 11 is provided with a circular recess 11a formed on a surface thereof facing the impact punch 13. In the recess 11a, a pellet 8 made of a metallic raw material with extensibility is inserted. The impact holder 12 supports the impact punch 13 reciprocally movably in the longitudinal direction thereof.

The impact punch 13, which is a columnar member that is vertically reciprocated by an ascending/descending means (not shown), presses the pellet 8 inserted in the recess 11a of the impact die 11. The stripper 14, which is provided with a through-hole in the thickness direction thereof for allowing the insertion of the impact punch 13 therethrough, aids the release of the cup-shaped workpiece 17 from the tip end of the impact punch 13 as the impact punch 13 moves away from the impact die 11 upon completion of molding of the cup-shaped workpiece 17.

In the step illustrated in FIG. 2A, the pellet 8 is inserted in the recess 11a of the impact die 11. Zinc, aluminum, magnesium, and the like are generally used for the pellet 8 because of their extensibility suitable for impact molding and because the reduction in weight of the finally obtained battery can be achieved.

In the step illustrated in FIG. 2B, the impact punch 13 descends, and the tip end thereof is pressed into the recess 11a. The pellet 8 is squeezed by the impact punch 13 and forced into the clearance between the outer peripheral surface of the impact punch 13 and the inner peripheral surface of the recess 11a. As this proceeds, the pellet 8 is stretched along the outer peripheral surface of the impact punch 13, and thus forged. The impact punch 13 descends by a predetermined stroke. In such a manner, the pellet 8 is formed into the bottomed cylindrical cup-shaped workpiece 17.

In the step illustrated in FIG. 2C, the impact punch ascends and returns to the origin where the impact punch 13 had been positioned before descending. As the impact punch 13 ascends, the cup-shaped workpiece 17 is pulled out of the recess 11a while being adhered to the tip end of the impact punch 13, and then released from the impact punch 13 by the aid of the stripper 14.

The cup-shaped workpiece 17 is formed so as to have an inner diameter slightly greater than that of the battery can to be produced. As shown in FIG. 3, the cup-shaped workpiece 17 has a variation in thickness of a side wall 17a, and the corner which is a boundary between the periphery of a bottom wall 17b and the side wall 17a is thicker than necessary. However, these unfavorable conditions in thickness can be eliminated in the below-described subsequent steps. According to impact molding, the cup-shaped workpiece 17 can be formed by one process with good productivity. In other words, the high productivity as conventionally obtained can be maintained.

In the step of adjusting a bottom wall thickness, the bottom wall 17b of the cup-shaped workpiece 17 is adjusted to a predetermined thickness and the bottom wall thickness d1 is made uniformed. Specifically, a shaping core is inserted into the cup-shaped workpiece, and the outer surface of the bottom wall of the cup-shaped workpiece is brought into contact with a flat plane. Subsequently, while the end surface of the shaping core and the flat plane is held so as to face each other in parallel, the bottom wall of the cup-shaped workpiece is sandwiched and squeezed between the end surface of the shaping core and the flat plane. Here, the end surface of the shaping core to be brought into contact with the inner surface of the bottom wall of the cup-shaped workpiece is flat or spherical concave. The spherical concave plane is a surface concave toward the interior of the shaping core. This step is described more specifically below.

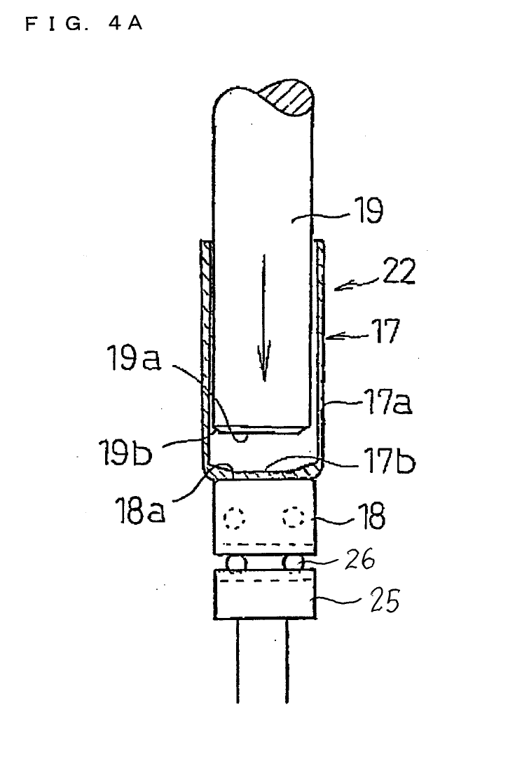

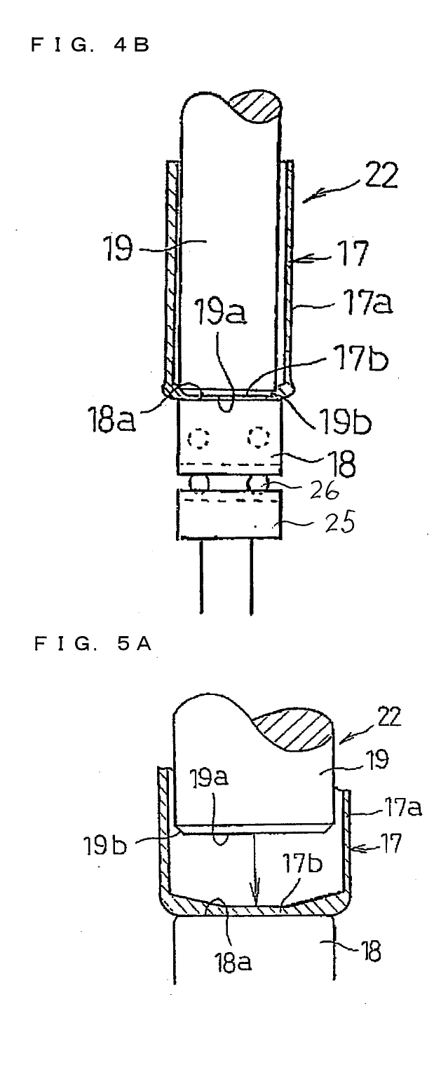

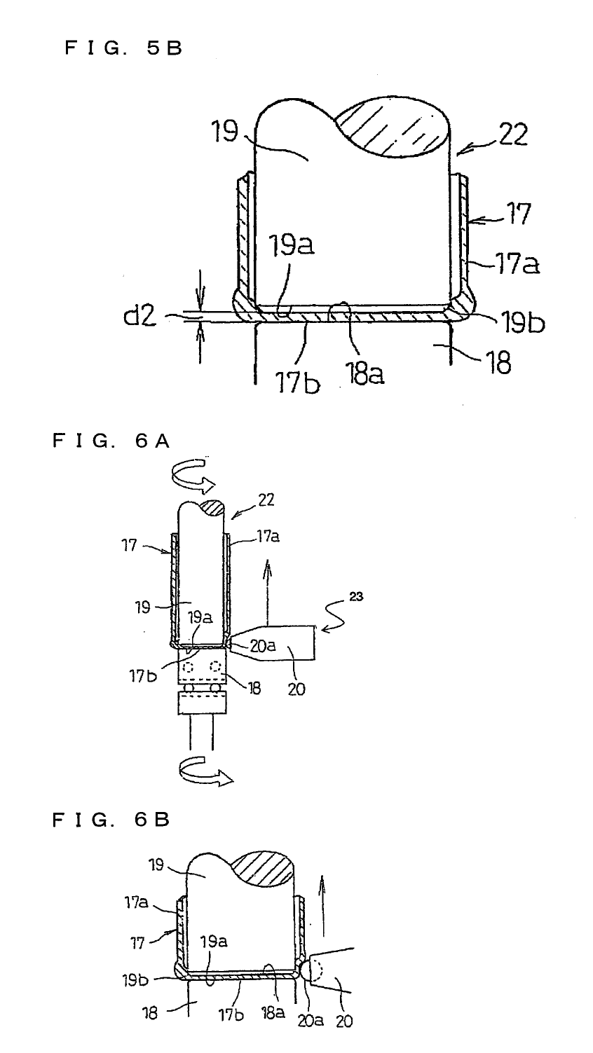

FIG. 4A to FIG. 4B are longitudinal cross-sectional views schematically showing a configuration of a press unit 22 and a step of adjusting a bottom wall thickness by the press unit 22. FIG. 4A illustrates a step of supplying the cup-shaped workpiece 17 to the press unit 22. FIG. 4B illustrates a step of adjusting the thickness of the bottom wall 17b of the cup-shaped workpiece 17. FIG. 5 is a set of longitudinal cross-sectional views showing main parts of the steps shown in FIG. 4. FIG. 5A is an enlarged view of a main part of the step illustrated in FIG. 4A. FIG. 5B is an enlarged view of a main part of the step illustrated in FIG. 4B.

The pressing unit 22 includes a rotary holding table 18 and a shaping core 19.

The rotary holding table 18 is a disc-shaped plate member rotatably supported by a rotary driving means 25 with bearings 26 interposed therebetween. The top surface of the rotary holding table 18 is a flat fixing plane 18a. On the fixing plane 18a, the cup-shaped workpiece 17 is placed such that the outer surface of the bottom wall 17b of the cup-shaped workpiece 17 is brought into contact therewith.

The shaping core 19 is a columnar member having an outer diameter identical to the inner diameter of the battery can 1 to be produced and having a flat end surface (i.e., lower end surface) 19a on the side to be brought into contact with the inner surface of the bottom wall of the cup-shaped workpiece 17. The entire periphery of the end surface 19a is chamfered into an annular inclined surface 19b. By providing the annular inclined surface 19b, in the steps of adjusting a bottom wall thickness and adjusting a side wall thickness, the reinforced thick-wall portion is automatically formed on the boundary between the bottom wall and the peripheral side wall.

The shaping core 19 is rotatably supported by a driving means (not shown). The rotary holding table 18 and the shaping core 19 are coaxially disposed. By performing the below-described steps using this shaping core 19, the battery can 1 in which the bottom wall and the side wall have a predetermined thickness, and the thicknesses of the bottom wall and the side wall are respectively uniform can be obtained.

In this embodiment, the end surface 19a of the shaping core 19 is flat, but not limited thereto, and may be spherical concave. By performing the below-described steps using the shaping core with a concave end surface, a battery can in which the thickness of the bottom wall is increased from the periphery to the center thereof, the side wall has a predetermined thickness, and the side wall thickness is uniform can be obtained.

In the steps illustrated in FIG. 4A and FIG. 5A, the cup-shaped workpiece 17 is supplied to the press unit 22. Specifically, the cup-shaped workpiece 17 is placed on the fixing plane 18a, and the position of the cup-shaped workpiece 17 is adjusted so as to be coaxial with the shaping core 19. Subsequently, the shaping core 19 is descended and inserted into the cup-shaped workpiece 17.

In the steps illustrated in FIG. 4B and FIG. 5B, the relative position between the rotary holding table 18 and the shaping core 19 is adjusted such that the fixing plate 18a of the rotary holding table 18 and the flat lower end surface 19a of the shaping core 19 face each other in parallel. With this relative position being maintained, the shaping core 19 is further descended to a lower limit where the clearance between the lower end surface 19a and the fixing plate 18a corresponds to the bottom wall thickness d2. By doing this, the bottom wall 17b is sandwiched and squeezed between the fixing plane 18a and the lower end surface 19a, and the almost entire bottom wall is formed uniformly to a predetermined thickness d2. As the bottom wall 17b is made thinner, the excess material is forced externally.

At this time, the bottom wall 17b uniformly formed to the predetermined thickness d2, is vertically sandwiched between the fixing plane 18a of the rotary holding table 18 and the lower end surface 19a of the shaping core 19. As such, the cup-shaped workpiece 17 is automatically vertically sandwiched between the rotary holding table 18 and the shaping core 19, and secured. The cup-shaped workpiece 17 thus secured is transferred to the subsequent step of adjusting a side wall thickness.

In the step of adjusting a side wall thickness, the side wall 17a of the cup-shaped workpiece 17 is adjusted to a predetermined thickness and the bottom wall thickness d2 is uniformed. This step is performed by swaging. According to swaging, pressure is applied to the outer peripheral surface of the side wall 17a to plastically deform the metallic raw material of the side wall 17a, and the outer peripheral surface of the shaping core 19 is pressed onto the inner peripheral surface of the side wall 17a to obtain the side wall 17a having a predetermined thickness and being uniform in thickness.

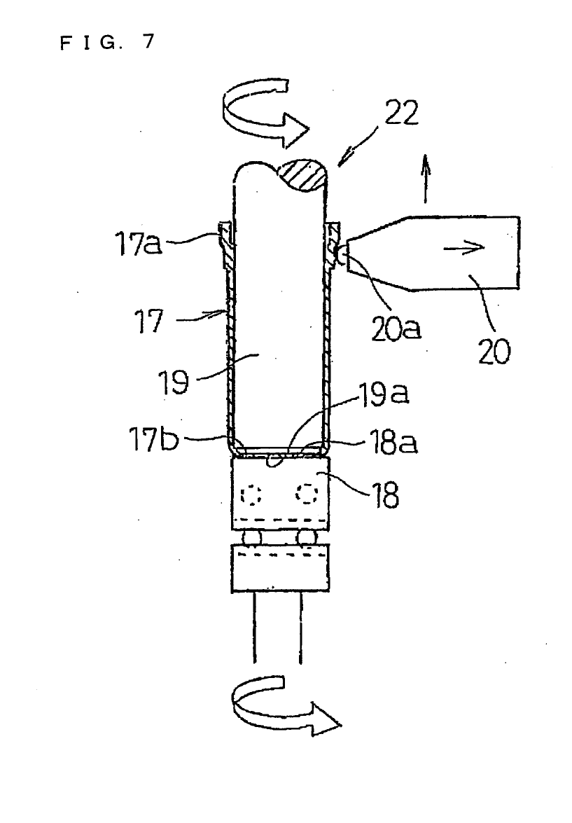

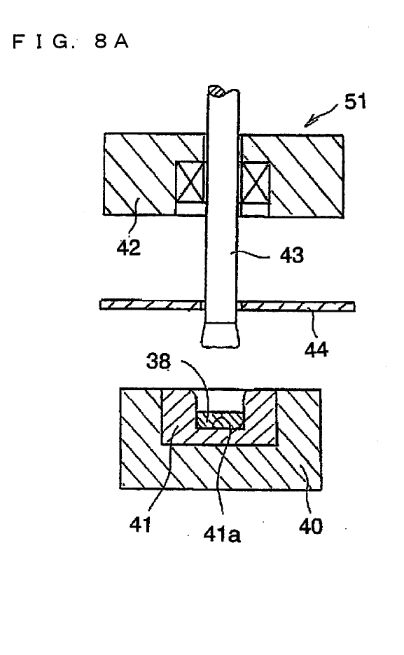

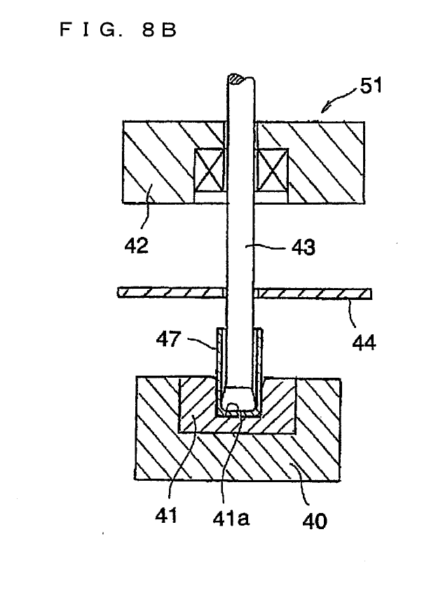

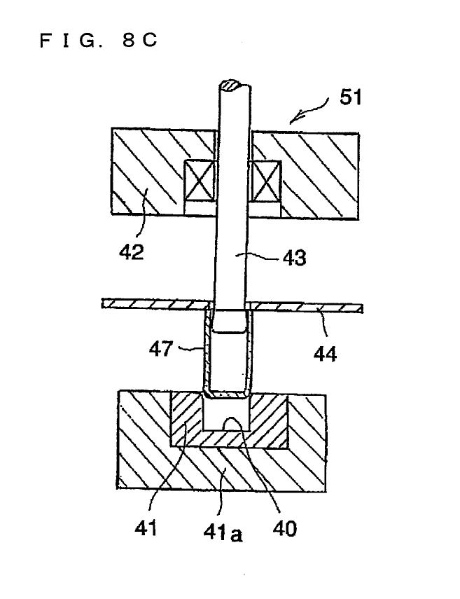

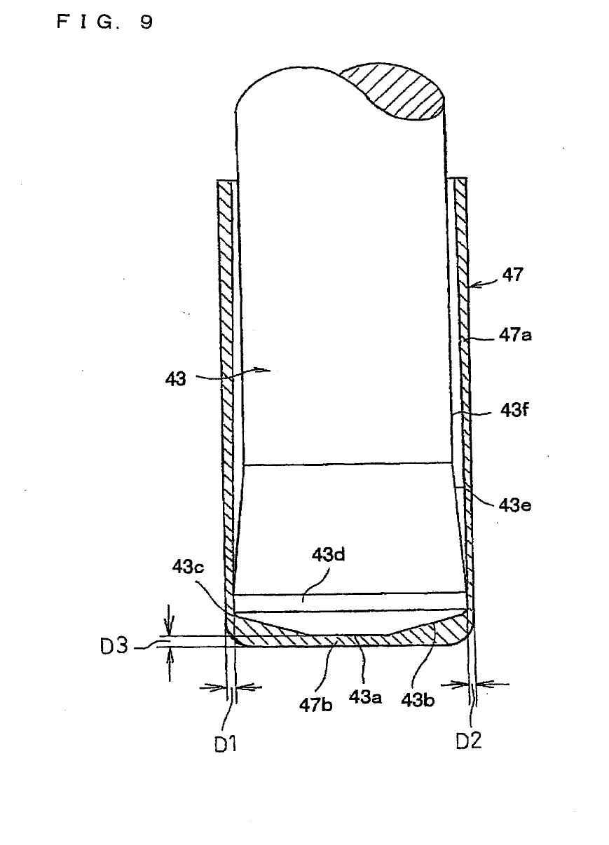

FIG. 6 is a set of side views explaining the step of adjusting a side wall thickness. FIG. 6A is a side view schematically showing a configuration of a swaging unit 23 and an early process of swaging. FIG. 6B is an enlarged side view showing a main part of the early process of swaging shown in FIG. 6A. FIG. 7 is a side view schematically showing a late process of swaging. Here, in FIG. 6 and FIG. 7, only the cup-shaped workpiece 17 is illustrated as a longitudinal cross-sectional view.

The swaging unit 23 includes a swaging tool 20 and a numerical control (NC) unit (not shown). The swaging tool 20 includes a spherical swaging member 20a rotatably supported at the tip end thereof. When the swaging tool 20 is used, the swaging member 20a, which is pressed onto the side wall of the rotating cup-shaped workpiece 17, also rotates following the rotation of the cup-shaped workpiece 17, enabling a smooth swaging. In this embodiment, the swaging tool 20 is used, but not limited thereto, and other tools such as a spatula-like tool may be used. In the NC unit, the horizontal movement and vertical movement of the swaging tool 20 is numerically controlled with high precision.

In the early process of swaging as shown in FIG. 6, first, the cup-shaped workpiece 17 sandwiched between the rotary holding table 18 and the shaping core 19 is rotated about the axis thereof. The cup-shaped workpiece 17 is rotated by rotating the shaping core 19. As described above, the shaping core 19 is rotatably supported by the driving means (not shown). Moreover, the cup-shaped workpiece 17 is securely sandwiched between the rotary holding table 18 and the shaping core 19. As such, the cup-shaped workpiece 17 and the rotary holding table 18 rotate in synchronization with the rotation of the shaping core 19.

Next, the rotating cup-shaped workpiece 17 is subjected to swaging with the swaging unit 23. The swaging unit 23, as shown in FIG. 6, allows the swaging tool 20 to be brought in proximity to the side of the bottom wall 17b of the rotating cup-shaped workpiece 17, and then allows the swaging member 20a to be pressed onto the portion protruding outward from the bottom wall 17b of the cup-shaped workpiece 17. While being held in this state, the swaging tool 20 is positioned so that the clearance between the outer peripheral surface of the shaping core 19 and the surface of the swaging member 20a becomes equal to the side wall thickness d1 of the side wall 2 of the battery can 1.

The cup-shaped workpiece 17, as described above, has an inner diameter slightly greater than the outer diameter of the shaping core 19. As such, the material forming the portion bulging outward from the bottom wall 17b and forming the side wall 17a is squeezed by the swaging member 20a and simultaneously pressed onto the outer peripheral surface of the shaping core 19. By doing this, the material is plastically deformed such that the excess material is partially pushed upward. The portion bulging outward from the bottom wall 17b is modified such that the contour thereof becomes identical to that of the boundary between the bottom wall 3 and the side wall 2 of the battery can 1 as shown FIG. 1.

Subsequently, the late process of swaging as shown in FIG. 7 is performed. The swaging unit 23 is controlled such that the swaging tool 20 moves vertically upward (toward the opening end of the cup-shaped workpiece 17 in the longitudinal direction thereof) while the relative position thereof is held such that the clearance between the outer peripheral surface of the shaping core 19 and the tip end of the swaging member 20a is equal to the side wall thickness d1. This movement is numerically controlled with extremely high precision.

In this movement, since the side wall 17a of the cup-shaped workpiece 17 is pressed by the swaging member 20a as the swaging member 20a moves vertically upward, the side wall 17a, while undergoing plastic deformation, is in turn pressed onto the outer peripheral surface of the shaping core 19. Further, as described above, since the clearance between the outer peripheral surface of the shaping core 19 and the tip end of the swaging member 20a is constantly equal to the side wall thickness d1, the side wall 17a of the cup-shaped workpiece 17 is plastically deformed so as to be forced into a shape having the same inner diameter and the same thickness d1 as those of the side wall 2 of the battery can 1.

When the swaging tool 20 moves and reaches a predetermined point with respect to the opening end of the cup-shaped workpiece 17, the NC unit starts the control for forming the sealing portion 7. Specifically, the swaging tool 20 is slightly moved vertically away from the shaping core 19 by a predetermined distance. As a result, the swaging tool 20 is positioned so that the clearance between the outer peripheral surface of the shaping core 19 and the tip end of the swaging member 20a becomes equal to the thickness of the sealing portion 7 in the battery can 1 as shown in FIG. 1.

Upon completion of positioning, the NC unit allows the swaging tool 20 to be ascended vertically upward with high precision while the clearance between the outer peripheral surface of the shaping core 19 and the tip end of the swaging member 20a is reliably maintained. When the swaging member 20a moves and reaches the opening end of the cup-shaped workpiece 17, the swaging is completed. In such a manner, the sealing portion 7 having a thickness slightly greater than the side wall thickness is formed, whereby the battery can 1 as shown in FIG. 1 is obtained.

As described above, according to the method for producing a battery can of the present invention, the bottomed cylindrical battery can 1, which is one of embodiments of the present invention as shown in FIG. 1, can be produced with high precision and high productivity. Specifically, in this production method, the cup-shaped workpiece 17 is processed from the pellet 8 until the cup-shaped workpiece 17 has almost the same shape as the battery can 1, in a single process by the impact molding in the step of forming a cup-shaped workpiece. Therefore, it is possible to maintain the high productivity achieved by the conventional production method in which a battery can is produced in a single process by impact molding.

In the step of adjusting a bottom wall thickness, the bottom wall 17b of the cup-shaped workpiece 17 having been positioned and placed on the fixing plane 18a of the rotary holding table 18 is squeezed by the flat end surface (lower end surface) 19a of the shaping core 19 so that the thickness throughout the bottom wall 17b is uniformly reduced to the bottom wall thickness d2. At this time, the rotary holding table 18 and the shaping core 19 are set to a relative position in which the flat fixing plane 18a and the flat end surface 19a of these are parallel to each other. In addition, the descending stroke of the shaping core 19 is precisely controlled such that the clearance between the fixing plane 18a and the end surface 19a of the shaping core 19 becomes equal to the bottom wall thickness d2.

Consequently, it is possible to highly precisely modify the bottom wall 17b of the cup-shaped workpiece 17 so as to have the thickness d2 uniformly therethroughout. Moreover, since in the step of adjusting a bottom wall thickness, the annular inclined surface 19b is provided on the entire periphery of the end surface 19a of the shaping core 19, the reinforced thick-wall portion 4 is automatically formed on the boundary between the bottom wall 3 and the side wall 2.

At the end of the step of adjusting a bottom wall thickness, the bottom wall 17b of the cup-shaped workpiece 17 is sandwiched and secured between the rotary holding table 18 and the shaping core 19. While being held in this state, the cup-shaped workpiece 17 is rotated in synchronization with the shaping core 19 by rotating the shaping core 19, during which swaging is performed. In the swaging, the swaging tool 20 is moved while the relative position between the shaping core 19 and the swaging member 20a is maintained such that the tip end of the shaping core 19 and the outer peripheral surface of the swaging member 20a have a predetermined clearance therebetween, and the movement is highly precisely controlled by numerical control mechanism. Specifically, the swaging tool 20 is moved along the outer peripheral surface of the shaping core 19 to plastically deform the side wall 17a. As a result, the side wall 2 is modified so as to have a predetermined side wall thickness d1 uniformly therethroughout.

Having been processed by impact molding, the cup-shaped workpiece 17 tends to have a warpage and is unlikely to be formed into a precise contour. The side wall 17a also tends to have a warpage. However, correction can be made so that the corner between the bottom wall 3 and the side wall 2 has an almost exact right angle, since the side wall 17a of the cup-shaped workpiece 17 is modified by the swaging tool that moves exactly parallel to the outer peripheral surface of the shaping core 19, while being sandwiched and secured between the lower end surface 19a of the shaping core 19 and the fixing plane 18a of the rotary holding table 18, the lower end surface 19a and the fixing plane 18a being disposed exactly parallel to each other.

When the swaging tool 20 moves and reaches a predetermined point in the vicinity of the opening end of the cup-shaped workpiece 17, the swaging tool 20 is moved horizontally. Specifically, in order to provide a predetermined clearance between the swaging member 20a and the shaping core 19, the swaging tool 20 is moved horizontally. Thereafter, the swaging tool 20 is moved again in parallel to the outer peripheral surface of the shaping core 19. In such a manner, the sealing portion 7 having a thickness slightly greater than the side wall thickness dl of the side wall 2 is formed in the vicinity of the opening end in an easy and precise manner. Moreover, advantageously, the side wall 2 and the sealing portion 7 can be formed continuously.

The battery can 1 obtained by the production method of the present invention can provide the above-discussed remarkable effects. In addition, fine spiral lines are formed on the outer peripheral surface of the side wall 2 since the side wall 2 is formed by plastically deforming the side wall 17a of the cup-shaped workpiece 17 by swaging in the step of adjusting a side wall thickness. These lines are formed as a result of the plastic deformation caused by the pressing of the swaging member 20a onto the side wall 17a of the cup-shaped workpiece 17 in a rotating state. The presence of these lines enhances the strength of the work-hardened side wall 2.

Although zinc is used as a metallic raw material in this embodiment to produce the battery can 1 for a manganese dry battery, aluminum or an aluminum alloy may be used as a metallic raw material to produce a bottomed cylindrical battery can for a lithium secondary battery. Specifically, since the production method of a battery can of the present invention utilizes impact molding in the step of forming a cup-shaped workpiece, it is necessary to use a metallic raw material with extensibility suited for impact molding. Aluminum and aluminum alloys, like zinc and magnesium, have excellent extensibility suited for impact molding.

In the step of adjusting a bottom wall thickness, the shaping core 19 is rotary-driven while the cup-shaped workpiece 17 is sandwiched and secured between the shaping core 19 and the rotary holding table 18, and in synchronization with this rotation, the cup-shaped workpiece 17 and the rotary holding table 18 are allowed to rotate. Alternatively, the rotary holding table 18 may be rotary-driven to rotate the cup-shaped workpiece 17 and the shaping core 19 in synchronization with this rotation. Further, in the step of adjusting a side wall thickness, although description is given by assuming that a swaging tool with the spherical swaging member 20a being rotatably mounted thereto is used as the swaging tool 20, other swaging tools such as a spatula-like tool may be used.

Furthermore, the sealing portion 7 with increased thickness is provided by making the outer diameter thereof greater than that of the side wall 2, but not limited thereto, and the sealing portion 7 with increased thickness may be provided by making the inner diameter thereof smaller than that of the side wall 2. The latter sealing portion 7 can be formed by way of providing the shaping core 19 with a smaller-diameter portion at a point corresponding to the sealing portion 7, the smaller-diameter portion having a slightly smaller outer diameter than the other portion of the shaping core 19.

Still further, according to the production apparatus of the present invention, the step of forming a cup-shaped workpiece can be faithfully embodied by the pressing unit for impact molding; the step of adjusting a bottom wall thickness can be faithfully embodied by the pressing unit including the rotary holding table and the shaping core; and the step of adjusting a side wall thickness can be faithfully embodied by attaching the rotary driving means to the pressing unit and including the swaging unit in the pressing unit. In particular, since the movement of the swaging tool is numerically controlled by the NC unit in the step of adjusting a side wall thickness, the side wall that uniformly has a required side wall thickness can be formed with extremely high precision.

### INDUSTRIAL APPLICABILITY

The battery can of the present invention is applicable to various cylindrical battery cans. Moreover, the production method of a bottomed cylindrical battery can according to the present invention is applicable in producing battery cans for use in various batteries. According to the production method of a battery can of the present invention, the production method of a battery can of the present invention is faithfully reproduced.

1. A bottomed cylindrical battery can comprising a side wall and a bottom wall made of a metallic raw material with extensibility, wherein
the side wall has a predetermined side wall thickness, the side wall being uniform in thickness and having an opening at one end in the longitudinal direction thereof; and,
the bottom wall has a predetermined bottom wall thickness, the bottom wall thickness being uniform or increasing from the periphery to the center thereof.

2. The bottomed cylindrical battery can in accordance with claim 1, wherein the bottom wall is formed by sandwiching and squeezing the bottom wall of a bottomed cylindrical cup-shaped workpiece having an open end in the longitudinal direction thereof, between two flat planes facing each other in parallel or between a spherical concave plane and a flat plane.

3. The bottomed cylindrical battery can in accordance with claim 1, wherein the side wall is formed by swaging a predetermined portion of the bottom wall and the side wall of the bottomed cylindrical cup-shaped workpiece having an open end in the longitudinal direction thereof.

4. The bottomed cylindrical battery can in accordance with claim 1, further comprising a reinforced thick-wall portion and a sealing portion, wherein
the reinforced thick-wall portion is provided at a boundary between the bottom wall and the side wall and has a thickness greater than the bottom wall thickness and greater than the side wall thickness, and
the sealing portion is provided at an opening end of the battery can or the vicinity thereof and has a thickness greater than the side wall thickness.

5. The bottomed cylindrical battery can in accordance with claim 1, furthermore comprising a fine line formed on the peripheral surface of the side wall, the line extending along the circumference of the side wall.

6. The bottomed cylindrical battery can in accordance with claim 1, wherein the metallic raw material is zinc, aluminum, or magnesium.

7. The bottomed cylindrical battery can in accordance with claim 1, wherein the bottom wall thickness is 0.1 to 0.4 mm, and the side wall thickness is 0.1 to 0.6 mm.

8. A method for producing a bottomed cylindrical battery can comprising the steps of forming a cup-shaped workpiece, adjusting a bottom wall thickness, and adjusting a side wall thickness, wherein
in the step of forming a cup-shaped workpiece, a cup-shaped workpiece is formed by impact molding, the cup-shaped workpiece comprising a metallic raw material with extensibility, having an opening at one end in the longitudinal direction thereof, and having an inner diameter greater than that of a battery can to be produced,
in the step of adjusting a bottom wall thickness, a shaping core is inserted into the cup-shaped workpiece, the shaping core having an outer diameter equal to the inner diameter of the battery can to be produced and having an end surface being flat or spherical concave at an end thereof, so that a flat or spherical concave plane is brought into contact with the outer surface of the bottom wall of the cup-shaped workpiece; and while the end surface of the shaping core and the flat or spherical concave plane are held so as to face each other in parallel, the bottom wall of the cup-shaped workpiece is sandwiched and squeezed between the end surface of the shaping core and the flat or spherical concave plane, so that the bottom wall is processed to have a uniform thickness or to have a thickness increasing from the periphery to the center of the bottom wall, and is provided with increased resistance to pressure; and
in the step of adjusting a side wall thickness, swaging is performed by applying pressure to the outer peripheral surface of the side wall of the cup-shaped workpiece while rotating the cup-shaped workpiece with the shaping core inserted thereinto, so that the metallic raw material composing the side wall is plastically deformed and the side wall is made uniform in thickness by the pressing of the outer peripheral surface of the shaping core onto the inner peripheral surface of the side wall.

9. The method for producing a bottomed cylindrical battery can in accordance with claim 8, wherein
in the step of adjusting a bottom wall thickness, the shaping core further has an annular inclined surface formed by chamfering on the circumference of the end surface thereof to be brought into contact with the inner surface of the bottom wall of the cup-shaped workpiece; and
in the step of adjusting a side wall thickness, the annular inclined surface of the shaping core is pressed onto a boundary between the bottom wall and the side wall containing the metallic raw material in a plastically deformed state, thereby to form a reinforced thick-wall portion having a thickness at the boundary, the thickness being greater than the bottom wall thickness and greater than the side wall thickness.

10. The method for producing a bottomed cylindrical battery can in accordance with claim 8, wherein
in the step of adjusting a side wall thickness, in performing swaging by pressing the outer peripheral surface of the side wall of the cup-shaped workpiece in a rotating state, swaging is started from the bottom of the outer peripheral surface of the side wall of the cup-shaped workpiece and stopped at a predetermined point below the opening end of the outer peripheral surface of the side wall of the cup-shaped workpiece, and then further swaging is performed such that the thickness of the metallic raw material in a plastically deformed state to be pressed onto the outer peripheral surface of the shaping core is increased.

11. An apparatus for producing a bottomed cylindrical battery can, comprising:
an impact molding unit for molding a pellet of metallic raw material with extensibility into a bottomed cylindrical cup-shaped workpiece having an opening at one end in the longitudinal direction thereof and having an inner diameter greater than that of a battery can to be produced;
a rotary holding table having a flat fixing plane for placing the cup-shaped workpiece thereon such that the outer surface of the bottom wall of the cup-shaped workpiece is brought into contact therewith;
a shaping core having an outer diameter equal to the inner diameter of the battery can to be produced and having an end surface being flat or concave at an end thereof to be brought into contact with the inner surface of the bottom wall of the cup-shaped workpiece;
a pressing unit for holding the shaping core such that the end surface of the shaping core and the flat plane of the rotary holding table face each other in parallel, and supporting the shaping core reciprocally movably in the longitudinal direction of the cup-shaped workpiece;
a rotary driving means for rotating at least one of the shaping core and the rotary holding table; and
a swaging unit including: a swaging tool to be pressed onto the outer peripheral surface of the side wall of the cup-shaped workpiece in a rotating state so that the side wall is plastically deformed; and a numerical control unit for numerically controlling the movement of the swaging tool.

12. The apparatus for producing a bottomed cylindrical battery can in accordance with claim 11, wherein the shaping core further has an annular inclined surface formed by chamfering on the circumference of the end surface thereof to be brought into contact with the cup-shaped workpiece.

13. The apparatus for producing a bottomed cylindrical battery can in accordance with claim 11, wherein the swaging tool is either a tool including a spherical swaging member and a supporting member for rotatably supporting the spherical swaging member or a spatula-like tool.
